(19) United States
(12) Patent Application Publication
(10) Pub. No.: US 2020/0077679 A1
(43) Pub. Date: Mar. 12, 2020

(54) BEVERAGE POWDERS AND RELATED METHODS

(71) Applicant: YMK Enterprises LLC, Fort Mill, SC (US)

(72) Inventor: Justin P. Johnston, Hilton Head Island, SC (US)

(73) Assignee: YMK Enterprises LLC

(21) Appl. No.: 16/555,353

(22) Filed: Aug. 29, 2019

Related U.S. Application Data
(60) Provisional application No. 62/729,095, filed on Sep. 10, 2018.

(51) Int. Cl. A23L 2/395; A23L 2/66; A23L 5/00

(52) U.S. Cl. CPC A23L 2/395; A23L 5/55; A23L 2/66

(57) ABSTRACT

Provided are beverage powders such as Bloody Mary powders that include one or more powdered dehydrated nightshade vegetables and/or nightshade fruits, one or more thickening agents, and one or more anti-caking agents. The beverage powders are formulated to be mixed with water, providing a desirable consistency and/or texture without requiring juice. A method of making a beverage such as a Bloody Mary using such a beverage powder includes mixing an effective amount of the beverage powder with water for an effective period of time.

### CROSS-REFERENCE TO RELATED APPLICATIONS

This application claims the benefit of priority to U.S. Provisional Application No. 62/729,095 filed Sep. 10, 2018, which is hereby incorporated by reference in its entirety.

### BACKGROUND

A “Bloody Mary” generally refers to a beverage or cocktail typically containing vodka or other spirits, mixed with tomato juice and/or other vegetable or fruit juice, and typically including combinations of other spices and flavorings. Some Bloody Mary beverages or cocktails may include, for example, Worcestershire sauce, hot sauce, garlic, herbs, horseradish, celery, olives, salt, black pepper, lemon juice, lime juice and/or celery salt. A Bloody Mary beverage or cocktail is usually consumed in the morning or early afternoon, and has also shown popularity as a hangover remedy.

While Bloody Mary beverages or cocktails have a certain popularity, the combination of ingredients used to mix a Bloody Mary beverage or cocktail have limited portability. Combinations of spices and other ingredients have been provided in powdered form, but these powders still require tomato juice or other vegetable juices to mix a Bloody Mary beverage or cocktail that presents a suitable consistency and/or texture.

Accordingly, there exists a need for improved beverage powders such as Bloody Mary beverage powders, improved beverages such as Bloody Mary beverages and cocktails that include a beverage powder, as well as improved methods of making beverage powders such as Bloody Mary beverage powders, and improved methods of mixing a beverage such as a Bloody Mary beverage or cocktail that include a beverage powder.

### BRIEF DESCRIPTION

Aspects and advantages will be set forth in part in the following description, or may be obvious from the description, or may be learned through practicing the presently disclosed subject matter.

In one aspect, the present disclosure embraces beverage powders. An exemplary beverage powder may include one or more powdered dehydrated vegetables and/or fruits, one or more thickening agents, and one or more anti-caking agents. The powdered dehydrated vegetables and/or fruits may include a nightshade vegetable and/or a nightshade fruit, such as tomato, tomatillo, eggplant, and/or pepper. The presently disclosed beverage powders are formulated to be mixed with water, providing a desirable consistency and/or texture without requiring juice. By way of example, the powdered dehydrated vegetables and/or fruits may include powdered dehydrated tomato, and/or the beverage powder may be a Bloody Mary powder.

The one or more thickening agents may include one or more polysaccharides and/or proteins. Exemplary thickening agents include starches, vegetable gums, and/or sugar polymers. An exemplary thickening agent may include xanthan gum. In some embodiments, the powdered dehydrated vegetables and/or fruits may be encapsulated with a thickening agents.

By way of example, the one or more anti-caking agents may include silicon dioxide (SiO2), calcium carbonate, magnesium carbonate, sodium aluminosilicate, sodium ferrocyanide, and/or potassium ferrocyanide.

In some embodiments, a beverage powder may include one or more energy supplements and/or recovery supplements. For example, a beverage powder may include caffeine and/or a Vitamin B complex.

In another aspect, the present disclosure embraces beverages made using beverage powder. Such beverages may exhibit a desirable consistency and/or texture without requiring juice. Spirits may optionally be included.

In yet another aspect, the present disclosure embraces methods of making a beverage, such as a Bloody Mary. An exemplary method may include mixing an effective amount of a beverage powder with water for an effective period of time, thereby providing a beverage that exhibits a desirable consistency and/or texture without requiring juice.

In yet another aspect, the present disclosure embraces methods of making a beverage powder, such as a Bloody Mary powder. A beverage powder can be made using one or more carefully controlled dehydration techniques, including thermal techniques, non-thermal techniques, as well as non-thermal hybrid drying techniques.

These and other features, aspects and advantages will become better understood with reference to the following description and appended claims. The accompanying drawings, which are incorporated in and constitute a part of this specification, illustrate exemplary embodiments and, together with the description, serve to explain certain principles of the presently disclosed subject matter.

### BRIEF DESCRIPTION OF THE DRAWINGS

A full and enabling disclosure, including the best mode thereof, directed to one of ordinary skill in the art, is set forth in the specification, which makes reference to the appended Figures, in which:

FIG. 1 schematically depicts an exemplary bag or pouch containing a beverage powder;

FIG. 2 schematically depicts an exemplary beverage or cocktail made using the beverage powder of FIG. 1;

FIG. 3 shows a flowchart depicting an exemplary method of making a beverage powder; and

FIG. 4 shows a flowchart depicting an exemplary method of making a beverage using a beverage powder.

Repeat use of reference characters in the present specification and drawings is intended to represent the same or analogous features or elements of the present disclosure.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

Here and throughout the specification and claims, range limitations are combined and interchanged, and such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems.

As used herein, the term “beverage” refers to a potable liquid that may or may not contain spirits. Thus, a beverage may include and refer to a spirited beverage or a non-spirited beverage, including those made using a beverage powder.

As used herein, the term “beverage powder” refers to a powdered material that contains one or more powdered dehydrated vegetables and/or fruits.

As used herein, the term “cocktail” generally refers to a beverage that contains spirits, including those made using a beverage powder.

As used herein, the term “juice” refers to natural liquid made by the extraction, pressing, and/or pulverizing of one or more vegetables and/or fruits. The term “juice” does not include a beverage or other liquid made using a beverage powder.

As used herein, the term “spirits” refers to a potable alcohol, such as those typically used when making a cocktail.

As used herein, the term “dehydration” refers to any process or combination of processes for removing moisture, including air-drying, sun-drying, freeze-drying, spray-drying, convective hot air drying, vacuum continuous belt drying, reduced pressure-low temperature drying, microwave-vacuum drying, pulsed electric field drying, ultraviolet drying, ultrasound drying, and so forth. The term “dehydrated” as applied to vegetables and/or fruits refers to vegetables and/or fruits that have been subjected to dehydration.

As used herein, the term “thickening” refers to and includes increasing viscosity, flocculating, coagulating, and/or gelling. The term “thickening agent” refers to an edible or potable material, whether in solid, liquid, and/or sol-gel form, capable of causing at least some thickening. The term “flocculating” or “flocculation” refers to a physical process of drawing colloids out of suspension in the form of a floc, including as a result of the addition of a thickening agent. The term “coagulating” or “coagulation” refers to a chemical process of drawing small particles (e.g., colloidal particles) together in the form of small clumps, at least in part by way of neutralizing some positive and/or negative charges among the particles such that van der Waals forces may cause the particles to agglomerate, such as in the form of a floc.

As used herein, the term “consistency” refers to flowability or free-liquid separation. Consistency may be referred to and include relative consistency, qualitative consistency, and/or quantitative consistency. Consistency may be quantified using a Bostwick consistometer.

As used herein, the term “texture” refers to oral-tactile qualities perceived in the mouth including, but not limited to, astringency, viscosity, graininess, slipperiness, roughness, uniformity, and mouth-coating, as perceived by a human.

The presently disclosed beverage powders provide for improved portability, particularly for beverages that have typically been prepared using juice. With the presently disclosed beverage powders, it becomes unnecessary to carry juice. Rather, the presently disclosed beverage powders are formulated to be mixed with water, providing a desirable consistency and/or texture without requiring juice. For example, for beverages that are typically prepared using juice, such as Bloody Mary beverages or cocktails, can be made using only beverage powder and water, and optionally spirits, and without requiring juice while, still providing a desirable consistency and/or texture.

The presently disclosed beverage powders may be enjoyed by anyone wishing to mix a powdered beverage, and may be suitable for use when on the go, such as when camping, boating, tailgating, or the like. Still others may appreciate the convenience of the presently disclosed beverage powders whether mixing beverages at home or in restaurants, bars or other establishment, for example, because maintaining tomato juice or other vegetable juice on hand is no longer necessary for preparing a satisfying Bloody Mary beverage. Similarly, restaurants, bars, and other establishments may realize significant savings on inventory storage and shipping costs when using the presently disclosed beverage powders. Any large or small bag, pouch, or container may be used to store the beverage powders, such as a bag, a pouch or packet (e.g., a tear-open pouch or packet), a jar or bottle, or the like. Larger quantities may be stored in bulk in bags, buckets, totes, or the like.

Beverages that include tomato juice such as a Bloody Mary have a particular consistency and/or texture that uniquely contribute to their palatability. This particular consistency and/or texture may be attributable to the use of tomato paste, tomato puree, or tomato pulp, especially when made from ripe whole tomato. Similarly, beverages that include other fruit and/or vegetable juices made using pastes, purees, or pulps may also have a particular consistency and/or texture that uniquely contributes to their palatability.

Without being bound to any theory, the palatability of beverages such as a Bloody Mary provide a hedonic reward associated with the activation of neural structures responsible for incentive salience that may be attributable at least in part to the particular consistency and/or texture of the beverage separately from or in addition to flavor or taste. This incentive salience confers a cognitive motivation involving a desire or want to experience the hedonic reward associated with such palatability, reinforcing pleasure or enjoyment of consuming such beverage. For example, most people have experienced the enhanced pleasure or enjoyment of drinking a fresh-squeezed glass of orange juice, relative to reconstituted or frozen orange juice. Of course, the fresh-squeezed orange juice has a particular consistency and/or texture that uniquely contributes to its palatability. In a similar way, other fruits and/or vegetable juices including tomato juice typically used in a Bloody Mary have a particular consistency and/or texture that uniquely contributes to their palatability.

On the other hand, when the consistency and/or texture of a beverage feels different from what was expected, the palatability of the beverage may decrease, triggering satiety queues associated with a reduced or quenched desire to experience negative feedback associated with such decreased palatability. In some instances, a consistency and/or texture that feels different from what was expected may result in a beverage being regarded as unpalatable. By way of example, some can relate to the unpalatable feeling of consuming a curdled beverage, such as curdled milk or a curdled beverage formed, for example, by combining an acidic juice with a cream-based product (e.g., a “cement mixer” formed by combining lime juice with Irish cream). As another example, those who enjoy whole milk may find skim milk unpalatable because of the difference in consistency and/or texture.

For many, the palatability of a beverage may be associated with the consistency and/or texture of the beverage being “as-expected.” In this way, the palatability of a beverage may provide a reinforcing feedback loop that ingrains the particular consistency and/or texture in the neural structures responsible for the incentive salience that drives the palatability of the beverages. When the consistency and/or texture are changed, palatability may decrease as a result of the change.

The presently disclosed beverage powders include a carefully controlled combination of powdered ingredients that allows a beverage made using the beverage power to closely replicate the consistency and/or texture of a beverage made using juice. Thus, the presently disclosed beverage powders may have good palatability, for example, because of the consistency and/or texture of the beverage being “as-expected.” These sensations may be determined using taste testing with samples prepared according to ASTM test method E1871-17, Standard Guide for Serving Protocol for Sensory Evaluation of Foods and Beverages; or, for beverages containing spirits, ASTM test method E1879-17, Standard Guide for Sensory Evaluation of Beverages Containing Alcohol.

The presently disclosed beverage powders can be mixed with water only, and/or optionally spirits, to a consistency and/or texture comparable to traditional beverages made using real vegetable or fruit juice and other liquid ingredients, such as a Bloody Mary beverage made from tomato juice and other liquid ingredients. Without being bound to any theory, this is made possible by the careful preparation of dehydrated vegetables and/or fruits together with the careful combination of one or more thickening agents and one or more anti-caking agents with one or more of such powdered dehydrated vegetables and/or fruits. For example, in the case of a Bloody Mary powder, powdered dehydrated tomato may be combined with one or more thickening agents and one or more anti-caking agents. The powdered dehydrated vegetables and/or fruits may provide the desired flavor, while the thickening agent(s) and anti-caking agent(s) may work in concert with one another as well as in concert with the powdered dehydrated vegetables and/or fruits, to provide the desired consistency and/or texture. More particularly, when a beverage powder is mixed with water (and/or spirits), the thickening agent(s) coagulate or otherwise thicken the mixture, while the anti-caking agents prevent excessive clumping of the powdered ingredients. As a result, vegetable and/or fruit juice is not necessary to prepare the presently disclosed beverages.

Together, the powdered dehydrated vegetables and/or fruits, thickening agents, and anti-caking agents work in synergy with one another when mixing with water to provide the flavor, texture, and consistency one would typically expect. For example, a Bloody Mary beverage made using the presently disclosed beverage powders may have a palatability that feels as though the beverage was made using real tomato juice. Any desired combination of powdered flavors and spices may be included as desired. Preferably, a beverage powder can be made entirely from natural ingredients, without artificial flavors or artificial preservatives. Exemplary beverage powders may be gluten free and non-GMO.

The consistency and/or texture of a juice may depend on the character and presence of insoluble and soluble cellular materials from the vegetable and/or fruit present in the juice. Insoluble components typically include a combination of whole cells, cell fragments, cell residues, and pectin components. Cell residues may include lignin, cellulose, hemicellulose, insoluble pectin components, and other insoluble polysaccharides. The character and presence of these components are typically fundamentally altered when vegetable and/or fruit material is formed into a powdered dehydrated material. Consequently, a beverage made from rehydrated powdered vegetable and/or fruit material historically has exhibited a markedly different consistency and/or texture relative to a beverage made from juice.

Without being bound to any theory, it is believed that the presence, character, and behavior of pectin in a beverage made from beverage powder plays a significant role in the resulting consistency and/or texture of the beverage. Pectin typically includes both soluble and insoluble components. The amount of pectin and the relative proportion of soluble and insoluble components typically depends on the particular vegetable or fruit, as well as the age or ripeness of the vegetable or fruit, among other things. Soluble pectin components may be lost in processing and/or may precipitate onto the surface of insoluble material. Certain edible nightshade vegetables and/or fruits may have a relatively higher concentration of soluble pectin material, which tends to make such nightshade vegetables and/or fruits more susceptible to exhibiting differences in consistency and/or texture as between a beverage made from beverage powder and a beverage made from juice.

Applicant has discovered, however, that a beverage powder that includes powdered dehydrated nightshade vegetables and/or nightshade fruits can be formulated in such a manner that a beverage made using such beverage powder may closely replicate the consistency and/or texture of a beverage made using juice. This is accomplished by careful preparation of such powdered dehydrated nightshade vegetables and/or nightshade fruits, together with the careful combination of such powdered dehydrated nightshade vegetables and/or fruits with one or more thickening agents and one or more anti-caking agents, all in accordance with the present disclosure.

Exemplary nightshade vegetables and/or nightshade fruits that are edible and may be utilized in a beverage powder in accordance with the present disclosure include a tomato, a tomatillo, an eggplant, and a pepper, as well as combinations of these. In some embodiments, a nightshade vegetable and/or nightshade fruit may be selected from among edible species within the solanum genus and/or capsicum genus.

While Bloody Mary powders are presented as an exemplary beverage powder, it will be appreciated that other beverage powders may also be provided without departing from the scope of the present disclosure. For example, the present disclosure additionally embraces beverage powders such as Caesar powder, Michelada powder (Red Beer powder), vegetable juice powder, and/or mollusks juice powder (e.g., clam juice powder, oyster juice powder, mussel juice powder, etc.), and so forth, as well as beverages made using any such beverage powder, methods of making any such beverage powder, and methods of making a beverage using any such beverage powder.

In some embodiments, a beverage made using a beverage powder may be perceived to have no sensory difference from a corresponding beverage made using juice (e.g., a commercially available beverage made using juice) rather than a beverage powder, either generally or particularly in respect of consistency, texture, and/or taste. By way of example, a Bloody Mary beverage made using a beverage powder may be perceived to have no sensory difference from a Bloody Mary beverage made using juice (e.g., a commercially available beverage made using juice) rather than a beverage powder. Such a beverage made using a beverage powder may be perceived to have no sensory difference in general as compared to a beverage made using juice. Additionally, or in the alternative, such a beverage made using a beverage powder may be perceived to have no sensory difference in respect of consistency, texture, and/or taste, as compared to a corresponding beverage made using juice (e.g., a commercially available beverage made using juice) rather than a beverage powder. Whether or not a sensory difference exists as between selected beverages may be determined by a sensory difference test performed according to ASTM test method E2139.

In some embodiments, a beverage made using a beverage powder maybe preferred over a corresponding beverage made using juice (e.g., a commercially available beverage made using juice) rather than beverage powder, either generally, or particularly in respect of consistency, texture, and/or taste. By way of example, a Bloody Mary beverage made using a beverage powder may be preferred over a Bloody Mary beverage made using juice (e.g., a commercially available beverage made using juice) rather than beverage powder. Additionally, or in the alternative, such a beverage made using a beverage powder may exhibit a consistency, texture, and/or taste that is preferred over that of a corresponding beverage made using juice (e.g., a commercially available beverage made using juice) rather than a beverage powder. Whether or not a preference exists as between selected beverages may be determined by a paired preference test performed according to ASTM test method E2263.

In some embodiments, a beverage made using a beverage powder may exhibit a favorable acceptance rating using the following 9-point hedonic scale: Like Extremely, Like Very Much, Like Moderately, Like Slightly, Neither Like nor Dislike, Dislike Slightly, Dislike Moderately, Dislike Very Much, Dislike Extremely, as determined by an external validity test performed according to ASTM test method E2943. As used herein, a favorable acceptance rating on the aforementioned 9-point hedonic scale includes Like Extremely, Like Very Much, Like Moderately, and/or Like Slightly. By way of example, a Bloody Mary beverage made using a beverage powder may exhibit a favorable acceptance rating using the aforementioned 9-point hedonic scale, as determined by an external validity test performed according to ASTM test method E2943.

An exemplary beverage made using a beverage powder may exhibit a. favorable acceptance rating of Like Slightly, Like Moderately, Like Very Much, or Like Extremely, as determined by an external validity test using the following 9-point hedonic, scale performed according to ASTM test method E2943. By way of example, a Bloody Mary beverage made using a beverage powder may exhibit a favorable acceptance rating of Like Slightly, Like Moderately, Like Very Much, or Like Extremely, as determined by an external validity test performed according to ASTM test method E2943.

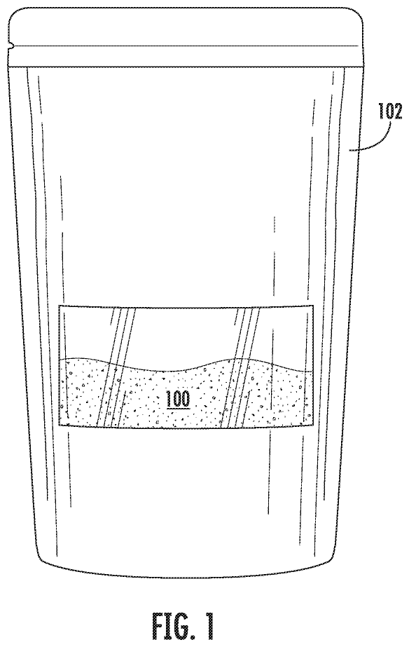

Referring to FIG. 1, in one aspect, the present disclosure provides a beverage powder 100, such as a Bloody Mary powder. The beverage powder 100 may be contained in a large or small bag or pouch 102, or any other suitable container. The bag or pouch 102 may be a resealable, flexible pouch, providing for convenient use and portability. By way of example, a Bloody Mary powder may include powdered dehydrated tomato, optionally other powdered dehydrated vegetables and/or fruits, one or more thickening agents, one or more anti-caking agents, and optionally a combination of powdered spices that may be varied for flavor. Other beverage powders 100 may include any desired powdered dehydrated vegetables and/or fruits, one or more thickening agents, one or more anti-caking agents, and a combination of powdered spices that may be varied for flavor. The particular powdered dehydrated vegetables and/or fruits included in a beverage powder 100 may be varied depending on the type of beverage intended to be made.

As further examples: a Caesar powder may include at least powdered dehydrated tomato and powdered dehydrated mollusks (e.g., powdered clam, powdered oyster, powdered mussel, etc.); a Michelada powder (e.g., a Red Beer powder) may include at least powdered dehydrated tomato and/or powdered dehydrated chili peppers. Any of the foregoing beverage powders may include, in addition to any one or more powdered dehydrated vegetables and/or fruits, one or more thickening agents, one or more anti-caking agents, and optionally a combination of powdered spices that may be varied for flavor.

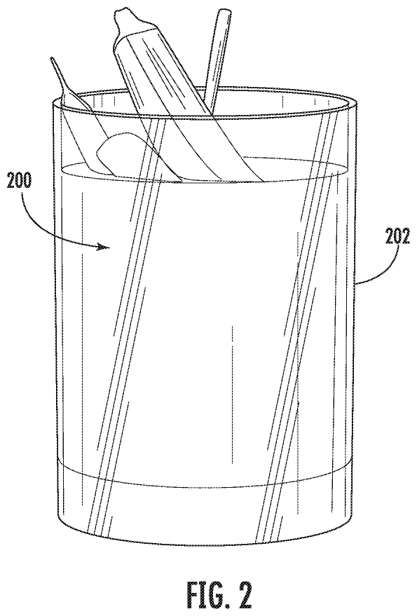

Now referring to FIG. 2, in another aspect, the present disclosure provides a beverage 200 made using a beverage powder 100, such as a Bloody Mary beverage made using a Bloody Mary powder, with or without spirits. The beverage 200 may be provided in any suitable container 202, such as an open top glass or cup, or a sealed or sealable container such as a bottle. The beverage 200 can be made by combining a suitable amount of beverage powder 100 with liquid (e.g., water and/or spirits), and stirring or blending the resulting combination until the beverage powder 100 has suitably dispersed in the liquid.

In another aspect, the present disclosure provides a method of mixing a beverage that includes a beverage powder 100, such as a Bloody Mary beverage mixed using a Bloody Mary powder, with or without spirits. A beverage such as a Bloody Mary beverage can be made by combining the presently disclosed beverage powder with water only. Optionally, spirits such as vodka may be added with the water and powder mix to provide a Bloody Mary cocktail that contains spirits. Accordingly, an exemplary method includes pouring an effective amount of the presently disclosed beverage powder, such as a Bloody Mary powder, into a volume of water and mixing for an effective period of time.

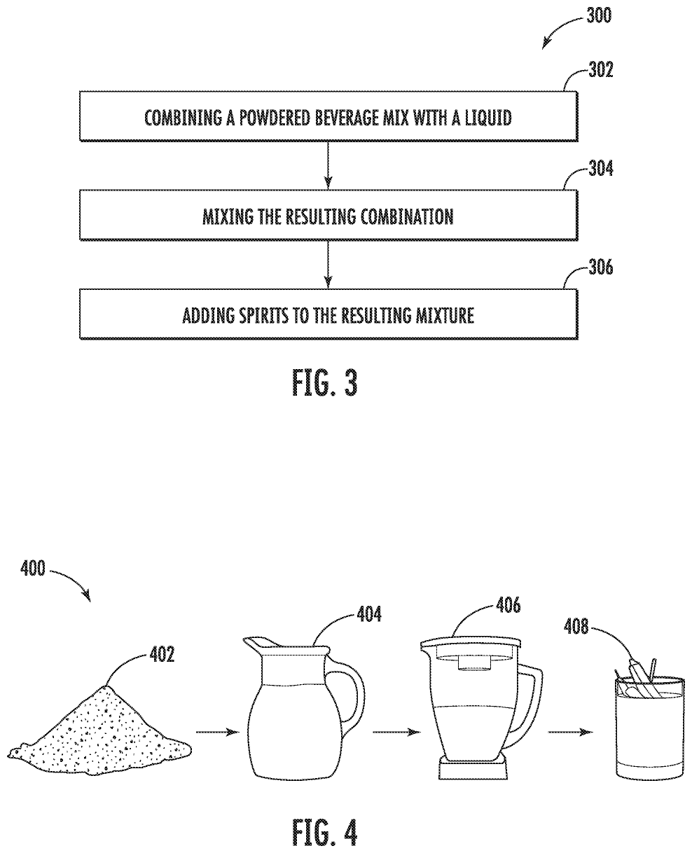

As shown in FIG. 3, an exemplary method 300 of making a beverage that includes a beverage powder 100 may include, at step 302, combining a beverage powder 100 with a liquid; and at step 304, mixing the resulting combination. The beverage powder 100 may be added to liquid, or the liquid may be added to the beverage powder 100. The amount of beverage powder 100 used in the method 300 may be an effective amount. Stirring or blending may be performed by hand (e.g., using a spoon, mixer, cocktail shaker, shaker bottle, etc.) or using a powered blender. The liquid may be or include water and/or spirits. Juice is not required. Advantageously, the presently disclosed beverage powders 100 may be suitably dispersed after a few seconds of stirring or mixing, such as from about 5 seconds to about 60 seconds. With a powered blender, about 5 to about 30 seconds may be adequate. When mixing by hand, about 30 seconds to about 60 seconds may be adequate.

As shown in FIG. 4, an exemplary method 400 of making a beverage that includes a beverage powder 100 using a powder blender may include, at step 402, opening a packet 102 of beverage powder 100, at step 404, adding water to an effective amount of beverage powder 100 or vice versa, at step 406, blending the mixture for an effective period of time (e.g., from about 5 to 30 seconds, or from about 5 to 10 second), and at step 408, adding an effective amount of spirits to the beverage.

Advantageously, tomato juice or other vegetable or fruit juices are not required, and yet the presently disclosed beverages powders, such as Bloody Mary powders, provide a beverage with a comparable flavor, consistency, and/or texture relative to a beverage made using juice. In some embodiments, any difference in flavor, consistency, texture, and the like may be imperceptible even to a distinguished palate, for example, as between a Bloody Mary beverage mixed using a presently disclosed Bloody Mary powder versus a Bloody Mary beverage made using liquid ingredients such as tomato juice and/or other juice. Although the presently disclosed beverage powders do not require vegetable or fruit juice, it will be appreciated that any desired vegetable or fruit juice may be added without departing from the scope of the present disclosure. For example, a beverage can be made using a beverage powder, and although not required, vegetable and/or fruit juice may be added as desired, such as to introduce additional flavor varieties.

In yet another aspect, the present disclosure provides a method of making a beverage powder, such as a Bloody Mary powder. The presently disclosed beverage powders can be made using one or more carefully controlled dehydration techniques for providing dehydrated vegetable and/or fruit ingredients. Preferably, the one or more dehydration techniques are carried out in a manner that yields dehydrated vegetable and/or fruit ingredients that reconstitute quickly and retain much of their original flavor, color and nutritional value. Exemplary dehydration techniques include thermal techniques (e.g., convective hot air drying, drum drying, spray drying, etc.), non-thermal techniques (e.g., ultrasound, pulse electric field, and ultraviolet drying), as well as non-thermal hybrid drying techniques. Other exemplary drying techniques include sun drying, vacuum drying, freeze drying, fluidized bed drying, tray drying, hot-air drying, and so forth.

Drum drying involves dehydrating pureed vegetable and/or fruit ingredients at relatively low temperatures over a rotating drum. Sheets of dehydrated vegetable and/or fruit product are discharged from the drum, which can then be milled or ground into a desired flake and/or powder form. Drum drying is sometimes regarded as suitable for producing low-value products because of the resulting flakes as opposed to powder. However, drum drying may be a suitable dehydration technique for at least a portion of the vegetable and/or fruit material to be dehydrated, for example, because the flake material may contribute to the desired consistency and/or texture of the resulting beverage. Thus, in some embodiments, at least a portion of the vegetable and/or fruit material included in a beverage powder may be dehydrated using a drum drying technique. Additionally, or in the alternative, a drum drying technique may be suitable for certain types of vegetable and/or fruit material, such as vegetable and/or fruit material having a pulpy consistency and/or when such a pulpy consistency is desired. In some embodiments dehydrated vegetable and/or fruit ingredients made using a drum drying technique may be mixed with vegetable and/or fruit ingredients made using a different dehydration technique.

Spray drying techniques include nozzle-type spray drying as well as pulse combustion spray drying. Spray drying involves pulverizing vegetable and/or fruit material, and then introducing the material into a spray drying system (e.g., a nozzle-type spray drying system or a pulse combustion spray drying system). Spray drying typically provides a consistent particle size distribution, and may be particularly suitable for heat-sensitive vegetable and/or fruit materials. In some embodiments, a spray drying dehydration technique may be used to encapsulate vegetable and/or fruit material within another material, such as one or more other ingredients to be included in the beverage powder. For example, powdered dehydrated vegetable and/or fruit material may be encapsulated with one or thickening agents and/or anti-caking agents. The encapsulation of the vegetable and/or fruit material with a thickening agent and/or an anti-caking agent may advantageously affect the manner in which the resulting beverage powder mixes with and absorbs water or other liquid (e.g., spirits), as well as the manner in which the various ingredients in the beverage powder interact with one another when being mixed. For example, such encapsulation may provide a desired degree of thickening, including a desired balance between flocculation and coagulation. Such encapsulation may contribute at least in part to providing a beverage powder from which a beverage can be made having a desired consistency and/or texture.

In some embodiments, pulse combustion spray drying may be preferred over nozzle-type spray drying. For example, pulse combustion spray drying techniques typically subject the vegetable and/or fruit material to much lower shear than that of nozzle-type spray drying techniques. Additionally, pulse combustion spray drying systems typically can handle higher viscosities and solids loading than that of a nozzle-type spray drying system.

Non-thermal drying techniques may provide a dehydrated vegetable and/or fruit material that when rehydrated more closely resembles its original form, for example, because the lower temperature of non-thermal drying techniques reduces thermal degradation of the vegetable and/or fruit material relative to thermal drying techniques. Non-thermal hybrid drying techniques may include the combination of at least one thermal technique (e.g., convective hot air drying, drum drying, spray drying, etc.) with at least one non-thermal technique (e.g., ultrasound, pulse electric field, and ultraviolet drying). Exemplary non-thermal hybrid drying techniques may include, by way of example and without limitation, convective hot air drying combined with ultrasound, pulse electric field, or ultraviolet drying.

Any variety of vegetables and/or fruits may be selected to make a powdered dehydrated material for use in a beverage powder. By way of example, any variety of tomato may be used when making a Bloody Mary beverage powder or other beverage powder that includes tomato, including combinations of different tomato varieties. Other vegetables, fruits, and/or garnishes may similarly be prepared to provide any desired powdered dehydrated vegetable, powdered dehydrated fruit, and/or powdered dehydrated garnish. An exemplary beverage powder may include, carrot or powdered dehydrated carrot, pepper or powdered dehydrated pepper, garlic or powdered dehydrated garlic, kale or powdered dehydrated kale, avocado or powdered dehydrated avocado, spinach or powdered dehydrated spinach, olive or powdered dehydrated olive, asparagus or powdered dehydrated asparagus, artichoke or powdered dehydrated artichoke, cucumber or powdered dehydrated cucumber, baby corn or powdered dehydrated baby corn, okra or powdered dehydrated okra, beet or powdered dehydrated beet, pickle or powdered dehydrated pickle, as well as combinations of these.

In some embodiments, a powdered dehydrated vegetable or fruit may include a pickled vegetable or a powdered dehydrated pickled vegetable, or a pickled fruit or a powdered dehydrated pickled fruit. Any of the presently disclosed vegetables and/or fruits may be pickled, and powdered dehydrated pickled vegetables and/or fruits may be formed by dehydrating and powderizing any one or more pickled vegetables and/or fruits.

Exemplary peppers or powdered dehydrated peppers, and/or pickled peppers or powdered dehydrated pickled peppers, may include, by way of example and without limitation, jalapenos, cayenne peppers, chili peppers, Carolina reaper peppers, Ghost Peppers (Bhut Jolokia peppers), Trinidad Moruga Scorpion peppers, 7 Pot Douglah peppers, 7 Pot Primo peppers, 7 Pot Barrackpore peppers, 7 Pot Red peppers, Trinidad. Scorpion “Butch T” peppers, Naga Viper peppers, habanero peppers (e.g., Red Savina Habanero peppers), peppadews, or pepperoncini peppers, as well as combinations of these.

Regardless of which powdered dehydrated vegetables and/or fruits are included, the presently disclosed beverage powders may be mixed with water or only, and optionally spirits, to form a beverage, such as a Bloody Mary beverage, with the desired taste, texture, and consistency. In some embodiments, the desired taste, texture and consistency may be achieved at least in part by way of the inclusion of one or more thickening agents and/or anti-caking agents.

Exemplary thickening agents include polysaccharides and/or proteins. Suitable polysaccharides that may be used as a thickening agent include starches, vegetable gums, and/or sugar polymers. Exemplary starches include fecula, arrowroot, corn starch, potato starch, tapioca, or katukuri starch, as well as combinations of these. Exemplary vegetable gums include xanthan gum, alginin, guar gum, or locust bean gum, as well as combinations of these. Exemplary sugar polymers include agar, carboxymethyl cellulose, pectin, maltodextrin, polydextrose, or carrageenan, as well as combinations of these. Exemplary proteins include egg whites, gelatin, or collagen, as well as combinations of these. In an exemplary embodiment, a beverage powder, such as a Bloody Mary powder, may include a starch thickening agent and/or a vegetable gum thickening agent. In one preferred embodiment, and exemplary thickening agent includes xanthum gum and/or arrowroot.

The specific amount of any one or more thickening agents used in a beverage powder may be determined based on the resulting consistency and/or texture of a beverage made using such thickening agent(s). By way of example, the amount of a thickening agent included in a beverage powder may be from about 0.1 wt. % to 5.0 wt. %, such as from 0.1 wt. % to 3 wt. %, such as from 0.5 wt. % to 2 wt. %, or such as from 0.1 wt. % to 1 wt. %. The thickening agent may make up at least 0.1 wt. % of the beverage powder, such as at least 0.5 wt. %, such as at least 1 wt. %, such as at least 2 wt. %, or such as at least 3 wt. %. The thickening agent may make up less than 5 wt. % of the beverage powder, such as less than 3 wt. %, such as less than 2 wt. %, such as less than 1 wt. %, or such as less than 0.5 wt. %.

In addition or as an alternative to one or more thickening agents, the presently disclosed beverage powders may include one or more anti-caking agents. An anti-caking agent may help prevent powdered ingredients from caking when mixed with water and/or spirits. Suitable antic-caking agent may be soluble in water and/or spirits.

Exemplary anti-caking agents include silicon dioxide (SiO2), calcium carbonate, magnesium carbonate, sodium aluminosilicate, sodium ferrocyanide, or potassium ferrocyanide, as well as combinations of these. Still further exemplary anti-caking agents include 341 tricalcium phosphate, 460(ii) powdered cellulose, 470b magnesium stearate, 500 sodium bicarbonate, 535 sodium ferrocyanide, 536 potassium ferrocyanide, 538 calcium ferrocyanide, 542 bone phosphate (i.e. calcium phosphate), 550 sodium silicate, 551 silicon dioxide, 552 calcium silicate, 553a magnesium trisilicate, 553b talcum powder, 554 sodium aluminosilicate, 555 potassium aluminium silicate, 556 calcium aluminosilicate, 558 bentonite, 559 aluminium silicate, 570 stearic acid, or 900 polydimethylsiloxane, as well as combinations of these. An exemplary beverage powder, such as a Bloody Mary powder, may contain an anti-caking agent that includes silicon dioxide (SiO2).

The specific amount of any one or more anti-caking agents used in a beverage powder may be determined based on the resulting consistency and/or texture of a beverage made using such anti-caking agent(s). The amount of an anti-caking agent included in a beverage powder may be from about 0.1 wt. % to 5.0 wt. %, such as from 1 wt. % to 5 wt. %, such as from 1 wt. % to 3 wt. %, or such as from 0.5 wt. % to 2 wt. %. The anti-caking agent may make up at least 0.1 wt. % of the beverage powder, such as at least 0.5 wt. %, such as at least 1 wt. %, such as at least 2 wt. %, or such as at least 3 wt. %. The anti-caking agent may make up less than 5 wt. % of the beverage powder, such as less than 3 wt. %, such as less than 2 wt. %, such as less than 1 wt. %, or such as less than 0.5 wt. %.

In addition to the powdered dehydrated vegetables and/or fruits, thickening agents, and anti-caking agents, exemplary beverage powders may include any one or more of a variety of spices, powdered flavoring agents, and/or powdered dehydrated flavoring agents. For example, an exemplary beverage powder may include worcestershire powder, horseradish powder, Tabasco powder, black pepper, red pepper, lemon pepper, celery seed, fennel, dill, mustard, rosemary, parsley, bay, clove, ginger, mace, cinnamon, salt, celery salt, paprika, smoked paprika salt, vinegar powder, onion powder, garlic powder, beet powder, as well as combinations of these.

It will be appreciated that the foregoing ingredients for the presently disclosed beverage powders, including exemplary Bloody Mary powders, as well as the exemplary powdered dehydrated vegetables and/or fruits, thickening agents, anti-caking agents, spices, powdered flavoring agents and/or powdered flavoring agents are provided by way of example and not to be limiting. In fact, a Bloody Mary powder or any other beverage powder may include any ingredient that may be desirable in a beverage or beverage powder, any of which may be provided in powdered form and are within the scope of the present disclosure.

In some embodiments, a beverage powder, such as a Bloody Mary powder, may include one or more energy supplements and/or recovery supplements. Exemplary energy supplements include caffeine, yerba mate, creatine ginseng, taurine, green tea extract, guarana, green coffee extract, ginko bilboa, carnitine, glucuronolactone, as well as combinations of these. In an exemplary embodiment, a beverage powder, such as a Bloody Mary powder, may include caffeine. Exemplary recovery supplements include Vitamin B complex (e.g., vitamin B2 (riboflavin), vitamin B3 (niacin), vitamin B5 (pantothenic acid), vitamin B6 (pyridoxine hydrochloride), vitamin B9 (folic acid), and/or vitamin B12 (cyanocobalamin)), amino acids (e.g., L-Cysteine), chicory root extract, milk thistle extract, amala extract, Chinese date extract, grape extract, beet juice extract, antioxidants (e.g., Vitamin C, Vitamin E, Vitamin A, selenium), as well as combinations of these. In an exemplary embodiment, a beverage powder, such as a Bloody Mary powder, may include a B vitamin. In an exemplary embodiment, a beverage powder, such as a Bloody Mary powder, may include caffeine and a Vitamin B complex.

In some embodiments, a beverage powder, such as a Bloody Mary powder, may include an over-the-counter pain reliever, such as one or more nonsteroidal anti-inflammatory compositions. Exemplary over-the-counter pain relievers include aspirin, celecoxib, diclofenac, diflunisal, etodolac, ibuprofen, indomethacin, ketoprofen, ketorolac, nabumetone, naproxen, oxaprozin, piroxicam, salsalate, sulindac, tolmetin, as well as combinations of these.

In some embodiments, a beverage powder, such as a Bloody Mary powder, may include one or more superfoods or powdered dehydrated superfoods. Exemplary superfoods or powdered dehydrated superfoods include berries (e.g., blueberries, mulberries, blackberries, cranberries, goji berries), ginger, turmeric curcumin), green tea, eggs, legumes, nuts, sweet potato, mushrooms, seeds (e.g., chia seeds, sunflower seeds, pumpkin seeds, flaxseeds, hemp seeds, almonds, pecans, pistachios, walnuts, cashews, Brazil nuts, macadamia nuts), wheatgrass, seaweed, or dark leafy greens (e.g., kale, swiss chard, collard greens, turnip greens, spinach, lettuce, arugula), as well as combinations of these.

In some embodiments, a beverage powder, such as a Bloody Mary powder, may include one or more probiotics. Exemplary probiotics include fermented products that contain lactic acid bacteria, such as fermented vegetables or pickled vegetables (e.g., kimchi, pao cai, sauerkraut, etc.), fermented soy products (e.g., tempeh, miso, soy sauce, etc.), or fermented dairy products (e.g., yogurt, kefir, buttermilk, etc.), as well as combinations of these. Further exemplary probiotics include bacteria such as Acetobacter spp. (e.g., A. pasteurianus, A. aceti), Bifidobacterium spp. (e.g., B. bifidum), Gluconacetobacter spp. (e.g., G. xylinus, G. oxydans), Fructobactillus spp., Lactobacillus spp. (e.g., L. acidophilus, L. brevis, L. bulgaricus, L. coryniformis, L. fermentum, L. helveticus, L. kefiranofaciens, L. paraplantarum, L. pentoses, L. plantarum), Lactococcus spp. (e.g., L. fujiensis, L. garvieae, L. hircilactis, L. lactis, L. laudensis, L. nasutiterrnitis, L. piscium), Leuconostoc spp. (e.g., Leuconostoc argentinum, Leuconostoc citreum, Leuconostoc mesenteroides, Pediococcus pentosaceus), Saccharomycetaceae spp. (e.g., Saccharomyces cerevisiae, Zygosaccharomyces), Streptococcus thermophiles, or Weissella spp., as well as combinations of these.

In some embodiments, a beverage powder, such as a Bloody Mary powder, may include a powdered fish or shellfish (e.g., crustaceans or mollusks). Exemplary powdered fish may include salmon, sardines, and the like. Exemplary powdered shellfish may include crab, crayfish, lobster, shrimp, clams, mussels, oyster, scallop, escargot, and the like. Additionally, or in the alternative, a beverage powder may include fish protein powder, such as fish protein concentrate or fish protein isolate. In an exemplary embodiment, a beverage powder, such as a Bloody Mary powder, may include clam powder.

An exemplary beverage such as a Bloody Mary can be made using from about 0.5 to 2 grams of beverage powder, mixed with from about 900 to 1,100 mL of water. The resulting beverage may optionally be mixed with vodka or other spirits, such as from about 10 to 60 mL of vodka or other spirits with 400 to 600 mL of the resulting Bloody Mary beverage. The beverage powder preferably contains an amount of thickening agent(s) and anti-caking agent(s) effective to provide a desirable consistency and/or texture. Any desired amount of other ingredients may be included in accordance with the present disclosure, including powdered dehydrated tomato and other spices, flavoring, and the like may be added to preference. It will be appreciated that any combination of the presently disclosed beverage powders with water and/or spirits is within the scope of the present disclosure.

Without being bound to any theory, the consistency of a beverage made using beverage powder may depend on the nature, distribution, and/or composition of whole cells, cell fragments, and polysaccharides in the powdered dehydrated vegetable or powdered dehydrated fruit material. The process of powdering and/or dehydrating may affect consistency, for example, by augmenting the proportion of insoluble solids to total solids. Certain polysaccharides and/or proteins found in vegetables and/or fruits may be broken down by dehydration and/or powdering processes, affecting the consistency of a beverage made using such powdered materials. Some of these materials may rehydrate relatively differently from one another, which may also affect consistency. Additionally, or in the alternative, relatively smaller polysaccharides and/or proteins may stick to cell walls or cell wall fragments in the beverage powder when in powder form and/or during mixing, which may also affect consistency.

One or more thickening agents may be selectively included in a beverage powder so as to augment the consistency of a resulting beverage made using the beverage powder. For example, in some embodiments, a thickening agent selected for a beverage powder may be or include a polysaccharide and/or a protein that corresponds to a naturally occurring polysaccharide and/or a protein in the vegetable and/or fruit used to make powdered dehydrated material for the beverage powder. In some embodiments, a polysaccharide and/or a protein that is at least partially degraded during dehydrating and powdering may be selected as a thickening gent, such as to at least partially replace such degraded polysaccharide and/or protein material. For example, in some embodiments, a thickening agent may include a sugar polymer in an amount selected to yield a concentration of such sugar polymer in a beverage made from the beverage powder, such as Bloody Mary powder, that corresponds to a concentration of such sugar polymer in a beverage made using juice rather than beverage powder. Other thickening agents, such as polysaccharides and/or a proteins may be included with similar correspondence.

Such correspondence may be described by a ratio of a thickening agent component to a naturally occurring component, and may be from 0.5:1 to 5:1, such as from 0.5:1 to 2:1, such as from 0.8:1 to 1.2:1, such as at least 0.5:1, such as at least 0.8:1, such as at least 1:1, or such as at least 2:1, or such as less than 5:1, such as less than 2:1, such as less than 1:1, or such as less than 0.8:1. Polysaccharide concentration may be determined using high performance liquid chromatography.

In some embodiments, a beverage made using a beverage powder, such as a Bloody Mary powder, may exhibit a Bostwick consistency of from 2 cm to 10 cm as determined using a Bostwick consistometer, such as from 3 cm to 8 cm, such as from 4 cm to 7 cm. The Bostwick consistency may be determined using the Bostick consistometer with the beverage diluted with distilled water to 12 brix (° Bx) at 25 C and the results reported as the distance traveled (cm) in 30 seconds and the brix read through a table refractometer at 20 C.

In some embodiments, a beverage made using a beverage powder, such as Bloody Mary powder, may exhibit a total suspended solids (TSS) of from 10 ppm to 1,000 ppm as determined gravimetrically, such as from 10 ppm to 500 ppm, such as from 10 ppm to 100 ppm, such as from 10 ppm to 50 ppm, such as from 10 ppm to 35 ppm, such as at least 10 ppm, at least 35 ppm, at least 50 ppm, at least 100 ppm, at least 500 ppm, or such as less than 1,000 ppm, less than 500 ppm, less than 100 ppm, less than 50 ppm, or less than 35 ppm. The TSS may be determined for a beverage powder by diluting the beverage powder with distilled water to 12 brix.

In some embodiments, a beverage made using a beverage powder, such as Bloody Mary powder, may exhibit a viscosity of from 0.1 centipoise to 5 centipoise as determined gravimetrically, such as from 0.5 centipoise to 2 centipoise, such as from 0.5 to 1 centipoise, such as at least 0.1 centipoise, at least 0,5 centipoise, at least 1 centipoise, or at least 2 centipoise, or such as less than 5 centipoise, less than 1 centipoise, or less than 0.5 centipoise. The viscosity may be determined for a beverage powder by diluting the beverage powder with distilled water to 12 brix.

This written description uses examples (exemplary embodiments) to describe the presently disclosed subject matter, including the best mode, and also to enable any person skilled in the art to practice the presently disclosed subject matter, including making and using any article and performing any method. The patentable scope of the presently disclosed subject matter is defined by the claims, and may include other examples that occur to those skilled in the art. Such other examples are intended to be within the scope of the claims if they include elements that do not differ from the literal language of the claims, or if they include equivalent elements with insubstantial differences from the literal languages of the claims.

What is claimed is:

1. A beverage powder, comprising:
one or more powdered dehydrated nightshade vegetables and/or nightshade fruits;
one or more thickening agents; and
one or more anti-caking agents;
wherein the beverage powder is formulated to be mixed with water, providing a desirable consistency and/or texture without requiring juice.

2. The beverage powder of claim 1, wherein the one or more powdered dehydrated nightshade vegetables and/or nightshade fruits comprises tomato, tomatillo, eggplant, and/or pepper.

3. The beverage powder of claim 2, wherein the beverage powder is a Bloody Mary powder.

4. The beverage powder of claim 1, comprising: powdered dehydrated carrot, powdered dehydrated pepper, powdered dehydrated garlic, powdered dehydrated kale, powdered dehydrated avocado, powdered dehydrated spinach, powdered dehydrated olive, powdered dehydrated asparagus, powdered dehydrated artichoke, powdered dehydrated cucumber, powdered dehydrated baby corn, powdered dehydrated okra, powdered dehydrated beet, and/or powdered dehydrated pickle.

5. The beverage powder of claim 1, wherein the one or more thickening agents comprises one or more polysaccharides and/or proteins.

6. The beverage powder of claim 5, wherein the one or more thickening agents comprises one or more starches, vegetable gums, and/or sugar polymers.

7. The beverage powder of claim 1, wherein the one or more anti-caking agents comprises silicon dioxide (SiO2), calcium carbonate, magnesium carbonate, sodium aluminosilicate, sodium ferrocyanide, and/or potassium ferrocyanide.

8. The beverage powder of claim 1, wherein the one or more anti-caking agents comprises 341 tricalcium phosphate, 460(ii) powdered cellulose, 470b magnesium stearate, 500 sodium bicarbonate, 535 sodium ferrocyanide, 536 potassium ferrocyanide, 538 calcium ferrocyanide, 542 bone phosphate, 550 sodium silicate, 551 silicon dioxide, 552 calcium silicate, 553a magnesium trisilicate, 553b talcum powder, 554 sodium aluminosilicate, 555 potassium aluminium silicate, 556 calcium aluminosilicate, 558 bentonite, 559 aluminium silicate, 570 stearic acid, and/or 900 polydimethylsiloxane.

9. The beverage powder of claim 1, comprising:
at least one of the one or more powdered dehydrated nightshade vegetables and/or nightshade fruits encapsulated with at least one of the one or more thickening agents.

10. The beverage powder of claim 1, comprising:
one or more energy supplements and/or recovery supplements.

11. The beverage powder of claim 10, wherein:
the one or more energy supplements comprises caffeine; and/or
the one or more recovery supplements comprises a Vitamin B complex, an amino acid, chicory root extract, milk thistle extract, amala extract, Chinese date extract, grape extract, beet juice extract, and/or an antioxidant.

12. The beverage powder of claim 10, wherein the one or more energy supplements comprises caffeine and the one or more recovery supplements comprises a Vitamin B complex.

13. The beverage powder of claim 1, wherein:
a beverage made by mixing the beverage powder with water has an as-expected palatability, as determined using taste testing with samples prepared according to ASTM test method E1871-17;
a beverage made by mixing the beverage powder with water is perceived to have no sensory difference from a corresponding beverage made using juice, as determined by a sensory difference test performed according to ASTM test method E2139;
a beverage made by mixing the beverage powder with water is preferred over a corresponding beverage made using juice, as determined by a paired preference test performed according to ASTM test method E2263; and/or
a beverage made by mixing the beverage powder with water exhibits a favorable acceptance rating using a 9-point hedonic scale, as determined by an external validity test performed according to ASTM test method E2943.

14. The beverage powder of claim 1, wherein the beverage powder exhibits a Bostwick consistency of from 2 cm to 10 cm, as determined using a Bostick consistometer with the beverage diluted with distilled water to 12 brix at 25 C.

15. The beverage powder of claim 1, wherein the beverage powder exhibits a total suspended solids of from 10 ppm to 1,000 ppm, as determined gravimetrically with the beverage diluted with distilled water to 12 brix at 25 C.

16. The beverage powder of claim 1, wherein the beverage powder exhibits a viscosity of from 0.1 centipoise to 5 centipoise, as determined gravimetrically with the beverage diluted with distilled water to 12 brix at 25 C.

17. A beverage, comprising:
one or more powdered dehydrated nightshade vegetables and/or nightshade fruits;
one or more thickening agents;
one or more anti-caking agents; and
water;
wherein the beverage ex desirable consistency and/or texture without requiring juice.

18. The beverage of claim 17, wherein the one or more powdered dehydrated nightshade vegetables and/or nightshade fruits comprises tomato, tomatillo, eggplant, and/or pepper.

19. The beverage of claim 17, wherein the beverage is a Bloody Mary.

20. A method of making a beverage, the method comprising:
mixing an effective amount of a beverage powder with water for an effective period of time, wherein the beverage powder comprises:
one or more powdered dehydrated nightshade vegetables and/or nightshade fruits;
one or more thickening agents;
one or more anti-caking agents; and
wherein the beverage exhibits a desirable consistency and/or texture without requiring juice.
